(19) United States
(12) Patent Application Publication
(10) Pub. No.: US 2020/0312647 A1
(43) Pub. Date: Oct. 1, 2020

(54) ION TRANSPORT DEVICE

(71) Applicant: SHIMADZU CORPORATION, Kyoto-shi (JP)

(72) Inventors: Akiko IMAZU, Kyoto-shi (JP); Motohide Yasuno, Kyoto-shi (JP); Yoshinori Arita, Kyoto-shi (JP); Takao Nakatomi, Kyoto-shi (JP)

(73) Assignee: SHIMADZU CORPORATION, Kyoto-shi (JP)

(21) Appl. No.: 16/700,032

(22) Filed: Dec. 2, 2019

(30) Foreign Application Priority Data
Mar. 28, 2019 (JP) 2019-064358

(51) Int. Cl. H01J 49/06

(52) U.S. Cl. CPC H01J 49/065

(57) ABSTRACT

Provided is an ion transport device 1 including: a drift tube 10 having a plurality of ring-shaped electrodes 11 arranged in an axial direction; a housing 30 containing the drift tube 10; a drift-tube support member 21 supporting the drift tube 10 in relation to the housing 30; a detector 20 fixed to the drift tube 10 and configured to detect ions; and a vibration damper 22 provided on the drift-tube support member 21 and configured to absorb vibration which the drift-tube support member 21 receives from the housing 30. By such a configuration, an occurrence of noise in a detection signal of the detector 20 due to an influence of the vibration can be prevented.

### TECHNICAL FIELD

The present invention relates to an ion transport device used for an analysis of a sample or similar purpose.

### BACKGROUND ART

When a molecular ion generated from a sample molecule is made to move in a gaseous medium by an effect of an electric field, the ion moves at a speed depending on its mobility determined by the strength of the electric field, size of the molecule and other related factors. Ion mobility spectrophotometry (IMS) is a measurement technique which utilizes this mobility for an analysis of sample molecules. IMS is used in a device which separates various sample-derived ions according to their ion mobilities and subsequently detects those ions with a detector to create an ion mobility spectrum.

As a device for separating ions according to their ion mobilities, for example, an ion transport device described in Patent Literature 1 is used. This ion transport device includes a drift tube having a considerable number of ring-shaped electrodes which are identical in shape and arranged along a central axis. Within the drift tube, a direct-current electric field having a potential gradient in the axial direction is created by the voltages respectively applied to those ring-shaped electrodes. Ions are accelerated by this electric field in the axial direction. A set of electrodes consisting of a pair of comb electrodes having their respective teeth interleaved with each other, which is called the “shutter gate”, is placed between two neighboring ring-shaped electrodes at a predetermined position in the drift tube. An area on the upstream side of the shutter gate in the stream of ions is called the desolvation region, while an area on the downstream side is called the drift region. An ionizing section for generating ions from the droplets of a liquid sample is provided on the upstream side of the desolvation region. A detector for detecting ions is fixed to a portion of the drift tube on the downstream side of the drift region.

Within the drift tube, dry drift gas flows at a constant flow velocity in the opposite direction to the stream of ions. Ions generated in the ionizing section are made to move through the desolvation tube while colliding with this drift gas. Additionally, a heater is attached to the surrounding area of the drift tube. The desolvation of the ions is promoted by the heat supplied from this heater as well as the dry drift gas. The ions which have passed through the desolvation region are attracted to one of the two comb electrodes of the shutter gate during the period of time where a voltage is applied to the shutter gate. At the moment when the application of the voltage to the shutter gate is discontinued, the ions are simultaneously drawn into the drift region due to the direct-current electric field created within the drift region. Within the drift region, the ions are made to move through the direct-current electric field while colliding with the drift gas. Each ion moves within the drift region at a speed which depends on its mobility, and is detected by the detector at a timing corresponding to that mobility.

### CITATION LIST

### Patent Literature

Patent Literature 1: WO 2016/079780 A

### SUMMARY OF INVENTION

### Technical Problem

The detector includes a plate-shaped Faraday electrode for sensing ions and a grid electrode located closer to the drift region than the Faraday electrode. The grid electrode is a metallic plate in which a considerable number of holes (e.g. hexagonal holes) are formed. This electrode is intended to prevent induction of electric current in the Faraday electrode due to the movement of the approaching ions before the ions hit the Faraday electrode, thereby improving the rising characteristics of the detection signal. However, if an external vibration is transmitted to the detector via the drift tube, the Faraday electrode and the grid electrode will vibrate with different amplitudes and periods. This causes a temporal change in their electrostatic capacity, so that a noise component occurs in the signal.

As another problem, the heat generated by the heater attached to the surrounding area of the drift tube may possibly reach electronic components constituting the detector and affect the detection result (output signal) in the detector. Equipping the detector with a cooling mechanism for avoiding that problem significantly increases the cost of the device.

Furthermore, the heat generated by the heater may possibly cause the following problem depending on the configuration of the drift tube: For example, there is a type of drift tube which is formed by alternately stacking a considerable number of ring-shaped electrodes and ring-shaped ceramic insulators as well as clamping the stacked members between a pair of flanges located at both ends, using a plurality of tightening rods. A drift tube having such a configuration may undergo the loosening of the tightly stacked structure if the rods are thermally expanded to a greater extent than the stacked structure due to the heat from the heater.

The present invention is aimed at solving problems arising from vibration or heat in the ion transport device. Specifically, the first problem is to prevent an occurrence of noise in the detection signal of the detector due to the vibration. The second problem is to reduce the influence of the heat generated by the heat on the detector. The third problem is to reduce the influence of the heat generated by the heat on the drift tube.

### Solution to Problem

An ion transport device according to the first aspect of the present invention developed for solving the first problem includes:
a drift tube having a plurality of ring-shaped electrodes arranged in an axial direction;
a housing containing the drift tube;
a drift-tube support member configured to support the drift tube in relation to the housing;
a detector fixed to the drift tube and configured to detect ions; and
a vibration damper provided on the drift-tube support member and configured to absorb vibration which the drift-tube support member receives from the housing.

An ion transport device according to the second aspect of the present invention developed for solving the second problem includes:
a drift tube having a plurality of ring-shaped electrodes arranged in an axial direction; a housing containing the drift tube;
a drift-tube support member configured to support the drift tube in relation to the housing;
a detector fixed to the drift tube and configured to detect ions;
a heater located on a lateral side of the drift tube within the housing and separately from the drift tube; and
a heater support member provided separately from the drift-tube support member and configured to support the heater in relation to the housing.

An ion transport device according to the third aspect of the present invention developed for solving the third problem includes:
a drift tube including ring-shaped electrodes and ring-shaped insulation members alternately stacked;
two flanges provided so as to clamp the drift tube from both ends;
a plurality of rods arranged on the outside of the drift tube so as to extend in the axial direction of the drift tube;
a plurality of insertion holes formed in one or both of the flanges and allowing each of the plurality of rods to be individually inserted into one of the insertion holes;
a stopper provided at an end portion of each of the rods on the side on which the rods are inserted into the insertion holes, the stopper having a larger diameter than the insertion holes; and
an elastic member located between the stopper and the flange in which the plurality of insertion holes are formed, the elastic member configured to urge the flange toward the drift tube.

### Advantageous Effects of Invention

In the ion transport device according to the first aspect of the present invention, a vibration which the ion transport device receives from the outside via the housing is absorbed by the vibration damper provided on the drift-tube support member, whereby the vibration of the detector fixed to the drift tube is suppressed. Thus, an occurrence of noise in the detection signal of the detector is prevented.

In the ion transport device according to the second aspect of the present invention, the heater is arranged separately from the drift tube, while the heater is supported by the heater support member which is provided separately from the drift-tube support member. Therefore, the heater is not in contact with the drift tube. This configuration prevents the transfer of the heat from the heater to the detector, thereby reducing the influence of the heat on the detector.

In the ion transport device according to the third aspect of the present invention, even if the rods are thermally expanded to a larger extent than the stacked structure of the ring-shaped electrodes and the ring-shaped insulation members constituting the drift tube, the flanges being urged toward the drift tube by the elastic member prevents the loosening of the tightly stacked structure.

### BRIEF DESCRIPTION OF DRAWINGS

FIG. 1 is a sectional view showing one embodiment of the ion transport device according to the present invention.

FIG. 2 is a bottom view showing the ion transport device according to the present embodiment.

FIG. 3 is a partial bottom view showing a variation of the ion transport device according to the present embodiment.

### DESCRIPTION OF EMBODIMENTS

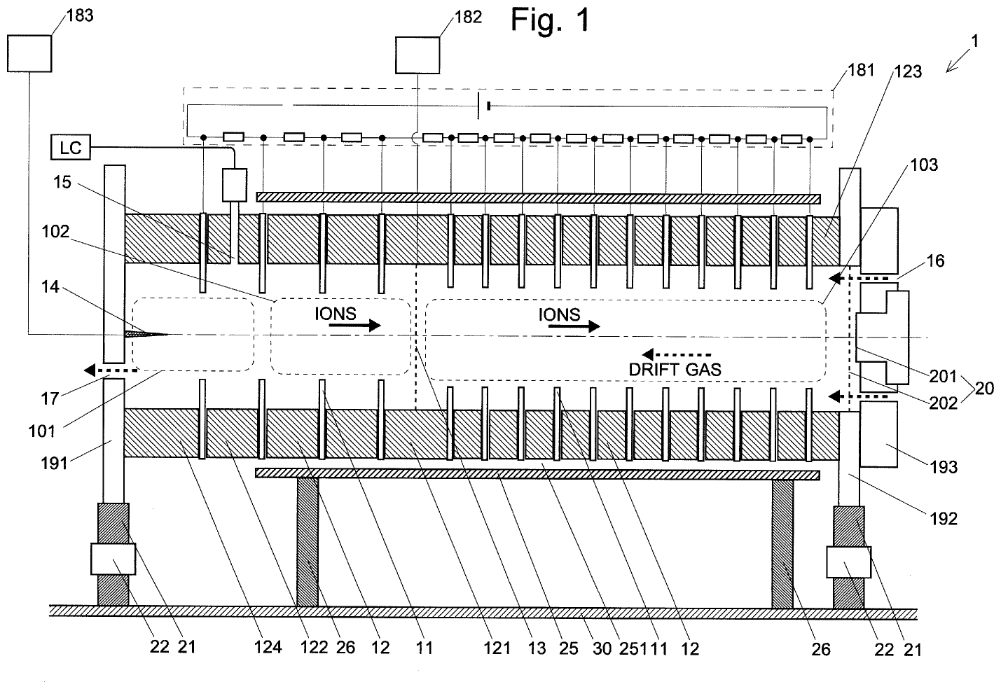

An embodiment of the ion transport device according to the present invention is hereinafter described using FIGS. 1-3.

### (1) Configuration of Ion Transport Device 1 According to Present Embodiment

The ion transport device 1 according to the present embodiment has a drift tube 10. The drift tube 10 includes a considerable number of ring-shaped electrodes 11 and ring-shaped insulation members 12 alternately stacked so that the ring-shaped electrodes 11 are arranged in the axial direction. The members located at both ends of the drift tube 10 are ring-shaped insulation members 12. The ring-shaped electrodes 11 are made of metal, such as stainless steel (SUS). The ring-shaped insulation members 12 used in the present embodiment are made of a ceramic material, although a different kind of material may be used as long as it is an electrically insulating material. The number of ring-shaped electrodes as well as that of the ring-shaped insulation members 12 are not limited to those shown in FIG. 1.

At both ends in the axial direction of the drift tube 10, there are a first flange 191, which is a disc-shaped member made of metal (e.g. stainless steel), and a second flange 192, which is a ring-shaped member formed by boring a hole at the center of a disc-shaped metallic member. The drift tube 10 is clamped by those first and second flanges 191 and 192.

In one ring-shaped insulation member 121 located closer to the first flange 191 than the center in the axial direction of the drift tube 10, a shutter gate 13 consisting of a pair of comb electrodes having their respective teeth interleaved with each other are provided within the inner space of the ring. In the present embodiment, the ring-shaped insulation members 12 located on the side closer to the first flange 191 than the shutter gate 13 are made to be thicker than the ring-shaped insulation members 12 located on the side closer to the second flange 192 so as to adjust the distance between the neighboring ring-shaped electrodes 11. However, the setting of the thicknesses of the ring-shaped insulation members 12 is not limited to this example.

A needle electrode 14 for corona discharge is provided on the surface of the first flange 191 facing the drift tube 10. One ring-shaped insulation member 122 located between the first flange 191 and the shutter gate 13 has a through hole extending from the outer surface to the inner space of the ring. A spray nozzle 15 is inserted into this through hole. The spray nozzle 15 is configured to make a liquid sample be carried by a stream of nebulizer gas (which is normally an inert gas, such as nitrogen or helium) and be sprayed into the drift tube 10 through a drying tube heated to a high temperature (approximately 300 to 500° C.). The liquid sample is supplied from a liquid chromatograph, for example.

A third flange 193 is fixed to the outer surface of the second flange 192 in terms of the axial direction of the drift tube 10 by bolts (not shown). The third flange 193 has gas introduction holes 16 as well as a Faraday electrode 201 of the detector 20 (which will be described later). Neutral gas (e.g. nitrogen gas) is supplied through those gas introduction holes 16 into the drift tube 10. This gas flows within the drift tube 10 from the second flange 192 toward the first flange 191, to be eventually discharged from a gas discharge port 17 formed in the first flange 191.

A first voltage supplier 181 is connected to each ring-shaped electrode 11. The first voltage supplier 181 includes a resistor array having serially connected electric resistors and a direct-current power source which applies a direct voltage between the two ends of the resistor array. The ring-shaped electrodes 11 are individually connected to the connection points located between the electric resistors in the resistor array. The connection of the electrodes to the connection points is made so that the potential of those electrodes sequentially decreases from the ring-shaped electrode 11 closest to the first flange 191 to the ring-shaped electrode 11 closest to the second flange 192. By such a connection, a direct-current electric field having a potential gradient from the first flange 191 to the second flange 192 is formed within the drift tube 10.

A second voltage supplier 182 is connected to the shutter gate 13. A direct-current voltage is thereby applied between the comb electrodes at a predetermined timing. A third voltage supplier 183 is connected to the needle electrode 14 to apply a voltage for discharging to the needle electrodes 14.

Within the space of the drift tube 10, the area closer to the first flange 191 than the ring-shaped insulation member 122 corresponds to an ionizing section 101. The area closer to the second flange 192 than the ionizing section 101 as well as closer to the first flange 191 than the shutter gate 13 corresponds to a desolvation region 102. The area closer to the second flange 192 than the shutter gate 13 corresponds to a drift region 103.

The detector 20 includes a plate-shaped Faraday electrode 201 and a grid electrode 202 located closer to the first flange 191 than the Faraday electrode 201. The Faraday electrode 201 is fixed to the third flange 193. The grid electrode 202 is a metallic plate in which a considerable number of hexagonal holes are arranged. This electrode is located within the second flange 192.

The first flange 191 and the second flange 192 are each provided with a drift-tube support member 21 which is a leg extending downward. Since the first flange 191 and the second flange 192 are fixed to the drift tube 10 (as will be described later), the drift tube 10 is supported by those drift-tube support members 21 on the bottom plate of a housing 30 which covers the ion transport device.

Each drift-tube support member 21 is provided with a vibration damper 22. The vibration damper 22 used in the present embodiment absorbs vibration by gel. The type of vibration damper is not limited to this one. For example, a damper which absorbs vibration by a metallic spring, rubber or urethane form may also be used.

The drift tube 10 is circumferentially covered by a tubular heater 25. A predetermined distance (e.g. 15 mm) of space 251 is left between the heater 25 and the drift tube 10. The heater 25 has two heater support members 26 in the form of legs extending downward. The heater support members 26 are provided separately from the drift-tube support members 21 and fixed to the bottom plate of the housing 30.

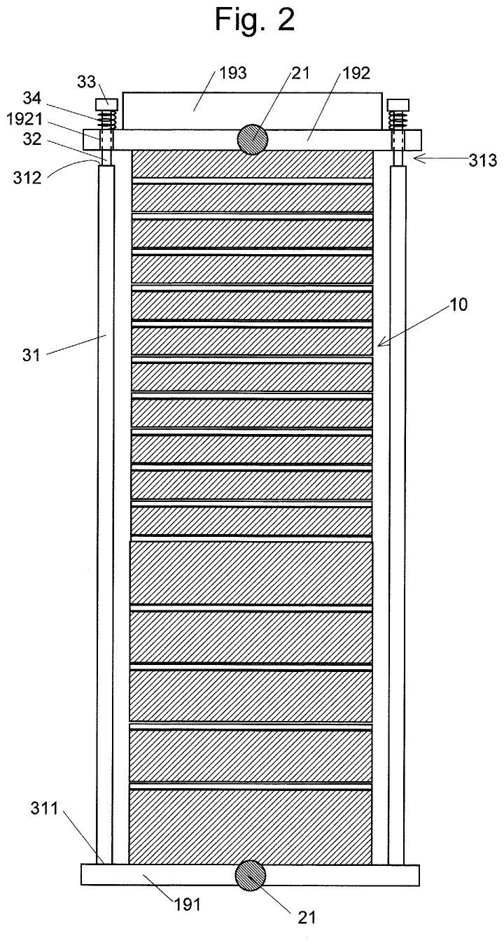

The ring-shaped electrodes 11 and the ring-shaped insulation members 12 are fixed by the configuration shown in FIG. 2 so that their position relative to each other will not be changed. A plurality of rods 31 extending along the axis of the drift tube 10 are provided on the outside of the drift tube 10. Resin is used as the material of the rods 31 since resin is inexpensive as well as easy to work.

Each rod 31 has one end portion 311 fixed to the first flange 191, whereas there is a gap 313 between the other end portion 312 of the rod 31 and the second flange 192. A rod-shaped projecting member 32 which is thinner than the rod 31 is attached to the end portion 312. The rod 31 and the projecting member 32 in combination can be considered as the rod in the present invention. The projecting member 32 is inserted into an insertion hole 1921 bored in the second flange 192. A stopper 33 consisting of a member having a larger diameter than the insertion hole 1921 is fixed to the tip of the projecting member 32. A bolt is used as the projecting member 32 and the stopper 33 in the present embodiment. That is to say, the projecting member 32 consists of the shank of the bolt, while the stopper 33 consists of the head of the bolt. By screwing the bolt into a hole formed in the end portion 312, the projecting member 32 and the stopper 33 can be easily attached to the rod 31.

Between the stopper 33 and the surface of the second flange 192 facing the stopper 33, an elastic member 34 consisting of a coil spring in a compressed form is wound around the projecting member 32. This elastic member 34 tries to extend, whereby the second flange 192 is urged toward the drift tube 10. Thus, the drift tube 10 is clamped by the first flange 191 and the second flange 192, whereby the ring-shaped electrodes 11 and the ring-shaped insulation members 12 are firmly held so that their position relative to each other will not be changed.

### (2) Operation of Ion Transport Device 1 According to Present Embodiment

An operation of the ion transport device 1 according to the present embodiment is hereinafter described.

The supply of the drift gas composed of dry neutral gas through the gas introduction holes 16 into the drift tube 10 is initiated. This supply of the drift gas is continued throughout the operation of the ion transport device 1.

Meanwhile, a liquid sample is supplied from a liquid chromatograph to the ion transport device 1. The liquid sample is carried by the stream of nebulizer gas and sprayed from the spray nozzle 15 into the ionizing section 101 through the drying tube heated to a high temperature (approximately 300 to 500° C.). The solvent contained in the droplets is vaporized, causing the target component in the sample to be gas molecules. In this state, a voltage is applied to the needle electrode 14 by the third voltage supplier 183, whereupon corona discharge is generated. Due to this corona discharge, the air, drift gas and other kinds of gas around the tip portion of the needle electrode 14 are ionized, whereby primary ions are generated. The primary ions generated in this manner reach the ionizing section 101 and react with the target component in the droplets or gas molecule of the target component vaporized from the droplets. Thus, an ion originating from the target component (target ion) is generated.

The target ion generated in the ionizing section 101 is made to move through the desolvation region 102 in the drift tube 10 toward the second flange 192 due to the effect of the direct-current electric field created within the drift tube 10 by the ring-shaped electrodes 11 and the first voltage supplier 181. Meanwhile, the heater 25 is energized to heat the space within the desolvation region 102. The heat from this heater 25 as well as the dry drift gas supplied from the gas introduction holes 16 promote the vaporization of the liquid from the droplets. Additionally, a direct-current voltage is applied between the comb electrodes of the shutter gate 13 by the second voltage supplier 182. The target ion which has reached the shutter gate 13 is thereby attracted toward the comb electrodes. After the application of the direct-current voltage between the comb electrodes has been continued for a predetermined period of time, the application of the voltage to the shutter gate is discontinued. At that moment, the target ion is drawn into the drift region 103 by the direct-current electric field created within the drift tube 10.

Within the drift region 103, the target ion is made to move through the direct-current electric field while colliding with the drift gas. The target ion moves through the drift region 103 at a speed depending on its mobility and hits the Faraday electrode 201 of the detector 20 at a timing corresponding to the mobility. Thus, the target ion is detected. It should be noted that, within the drift region 103, the heat from the heater 25 and the dry drift gas prevent the solvent molecules from once more attaching to the target ion.

In this situation, if vibration is applied to the detector 20 from the outside, the Faraday electrode 201 and the grid electrode 202 in the detector 20 will vibrate with different amplitudes and periods. This will lead to a temporal change in the electrostatic capacity, which will cause a noise component to occur in the detection signal. Such a situation can be avoided in the ion transport device 1 according to the present embodiment since the drift tube 10 is supported on the bottom plate of the housing 30 covering the ion transport device 1 by the drift-tube support member 21 equipped with the vibration damper 22. The vibration damper 22 absorbs the vibration received from the outside via the housing 30 and thereby prevents the detector 20 fixed in the drift tube 10 from vibration. Thus, an occurrence of noise in the detection signal of the detector 20 is prevented.

In the ion transport device 1 according to the present embodiment, the heater 25 is separated from the drift tube 10, and this heater 25 is supported by the heater support member 26 which is provided separately from the drift-tube support member 21. Therefore, the heater 25 is prevented from coming in contact with the drift tube 10. This configuration prevents the transfer of the heat from the heater 25 to the detector 20, and thereby reduces the influence of the heat on the detector 20.

Furthermore, in the ion transport device 1 according to the present embodiment, the second flange 192 is urged toward the drift tube 10 by the action of the elastic member 34, and the drift tube 10 is thereby clamped. Therefore, the loosening of the drift tube 10 will not occur even if the rods 31 are thermally expanded to a larger extent than the stacked structure of the ring-shaped electrodes 11 and the ring-shaped insulation members 12 constituting the drift tube 10 due to the heat generated by the heater.

### (3) Variations

The present invention is not limited to the previously described embodiment, but can be modified in various forms within the spirit of the present invention.

For example, the drift tube 10 in the previous embodiment is supported on the bottom plate of the housing 30 covering the ion transport device by the drift-tube support members 21. Alternatively, the drift-tube support members 21 may be fixed to the ceiling of the housing 30 to suspend the drift tube 10 from the ceiling. Similarly, the heater support members 26 may be fixed to the ceiling to suspend the heater 25 from the ceiling.

In the previous embodiment, the first flange 191 and the second flange 192 are each provided with the drift-tube support member 21. It is also possible to directly fix the drift-tube support members 21 to the drift tube 10. For example, the drift-tube support members 21 may be provided on the ring-shaped insulation members 123 and 124 located at both ends of the drift tube 10, or on other ring-shaped insulation members.

Although a coil spring is used as the elastic member 34 in the previous embodiment, a different type of elastic member may be used, such as a rubber or urethane form.

The projecting member 32, stopper 33 and elastic member 34 in the previous embodiment are provided on the second flange 192. It is also possible to provide those elements on the first flange 191, or on both the first flange 191 and the second flange 192.

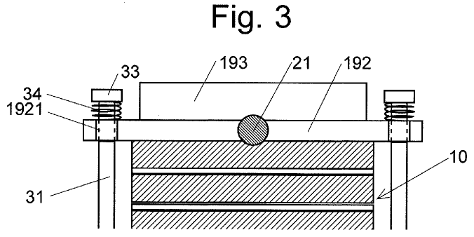

In the previous embodiment, the rod-shaped projecting member 32 thinner than the rod 31 is provided at the tip of the rod 31. It is also possible to omit the projecting member 32 and adopt the configuration as shown in FIG. 3. In this configuration, the rods 31 are inserted into the insertion holes 1921 formed in the second flange 192 (and/or the first flange 191), and the stopper 33 having a larger diameter than the insertion hole 1921 is formed at the tip of each rod 31, and the elastic member 34 is provided between this stopper 33 and the second flange 192 (and/or the first flange 191).

The configuration having the drift-tube support members 21 and the vibration dampers 22 can also be applied in the case where the heater support members 26 are not used. The configuration having the heater support members 26 can also be applied in the case where the drift-tube support members 21 without the vibration dampers 22 are used. The configuration having the vibration dampers 22 and/or the heater support members 26 can also be applied in the case of using a drift tube which does not have a structure formed by alternately stacking a considerable number of ring-shaped electrodes 11 and ring-shaped insulation members 12. The configuration having the stopper 33 and the elastic member 34 can also be applied in the case where the drift-tube support members 21 (and the vibration dampers 22) and/or the heater support members 26 are not provided.

### Modes of Invention

It should be easy for a person skilled in the art to understand that the previously described illustrative embodiment is a specific example of the following modes of the present invention.

### (Clause 1)

An ion transport according to one mode includes:
a drift tube having a plurality of ring-shaped electrodes arranged in an axial direction;
a housing containing the drift tube;
a drift-tube support member configured to support the drift tube in relation to the housing;
a detector fixed to the drift tube and configured to detect ions; and
a vibration damper provided on the drift-tube support member and configured to absorb vibration which the drift-tube support member receives from the housing.

In the ion transport device described in Clause 1, a vibration which the ion transport device receives from the outside via the housing is absorbed by the vibration damper provided on the drift-tube support member, whereby the vibration of the detector fixed to the drift tube is suppressed. Thus, an occurrence of noise in the detection signal of the detector is prevented.

The drift-tube support member may be configured to directly support the drift tube. Alternatively, it may be configured to indirectly support the drift tube by supporting another member (e.g. the first flange 191 and the second flange 192 in the previous embodiment) fixed to the drift tube. The detector may be directly fixed to the drift tube, or it may be fixed to another member which is directly or indirectly fixed to the drift tube (e.g. the third flange 193 in the previous embodiment).

### (Clause 2)

An ion transport device according to another mode of the present invention includes:
a drift tube having a plurality of ring-shaped electrodes arranged in an axial direction;
a housing containing the drift tube;
a drift-tube support member configured to support the drift tube in relation to the housing;
a detector fixed to the drift tube and configured to detect ions;
a heater located on a lateral side of the drift tube within the housing and separately from the drift tube; and
a heater support member provided separately from the drift-tube support member and configured to support the heater in relation to the housing.

In the ion transport device described in Clause 2, the heater is arranged separately from the drift tube, while the heater is supported by the heater support member which is provided separately from the drift-tube support member. Therefore, the heater is not in contact with the drift tube. This configuration prevents the transfer of the heat from the heater to the detector, thereby reducing the influence of the heat on the detector.

### (Clause 3)

An ion transport device according to the still another mode of the present invention includes:
a drift tube including ring-shaped electrodes and ring-shaped insulation members alternately stacked;
two flanges provided so as to clamp the drift tube from both ends;
a plurality of rods arranged on the outside of the drift tube so as to extend in the axial direction of the drift tube;
a plurality of insertion holes formed in one or both of the flanges and allowing each of the plurality of rods to be individually inserted into one of the insertion holes;
a stopper provided at an end portion of each of the rods on the side on which the rods are inserted into the insertion holes, the stopper having a larger diameter than the insertion holes; and
an elastic member located between the stopper and the flange in which the plurality of insertion holes are formed, the elastic member configured to urge the flange toward the drift tube.

In the ion transport device described in Clause 3, even if the rods are thermally expanded to a larger extent than the stacked structure of the ring-shaped electrodes and the ring-shaped insulation members constituting the drift tube, the flanges being urged toward the drift tube by the elastic member prevents the loosening of the tightly stacked structure.

### (Clause 4)

The ion transport device described in Clause 1 may further include:
a heater located on a lateral side of the drift tube within the housing and separately from the drift tube; and
a heater support member provided separately from the drift-tube support member and configured to support the heater in relation to the housing.

The ion transport device described in Clause 4, an occurrence of noise in the detection signal of the detector can be prevented, and furthermore, the influence of the heat on the detector can be reduced.

### (Clause 5)

The ion transport device described in Clause 1 or 2 may be configured as follows:
the drift tube includes ring-shaped electrodes and ring-shaped insulation members alternately stacked, and the device further includes:
two flanges provided so as to clamp the drift tube from both ends;
a plurality of rods arranged on the outside of the drift tube so as to extend in the axial direction of the drift tube;
a plurality of insertion holes formed in one or both of the flanges and allowing each of the plurality of rods to be individually inserted into one of the insertion holes;
a stopper provided at an end portion of each of the rods on the side on which the rods are inserted into the insertion holes, the stopper having a larger diameter than the insertion holes; and
an elastic member located between the stopper and the flange in which the plurality of insertion holes are formed, the elastic member configured to urge the flange toward the drift tube.

In the ion transport device described in Clause 5, an occurrence of noise in the detection signal of the detector can be prevented. Furthermore, the loosening of the tightly stacked structure does not occur even if the rods are thermally expanded to a larger extent than the stacked structure of the ring-shaped electrodes and the ring-shaped insulation members constituting the drift tube.

### REFERENCE SIGNS LIST

1 . . . Ion Transport Device
10 . . . Drift Tube
101 . . . Ionizing Section
102 . . . Desolvation Region
103 . . . Drift Region
11 . . . Ring-Shaped Electrode
12, 121, 122, 123, 124 . . . Ring-Shaped Insulation Member
13 . . . Shutter Gate
14 . . . Needle Electrode
15 . . . Spray Nozzle
16 . . . Gas Introduction Hole
17 . . . Gas Discharge Port
181 . . . First Voltage Supplier
182 . . . Second Voltage Supplier
183 . . . Third Voltage Supplier
191 . . . First Flange
192 . . . Second Flange
1921 . . . Insertion Hole
193 . . . Third Flange
20 . . . Detector
201 . . . Faraday Electrode
202 . . . Grid Electrode
21 . . . Drift-Tube Support Member
22 . . . Vibration Damper
25 . . . Heater
251 . . . Space between Drift Tube and Heater
26 . . . Heater Support Member
30 . . . Housing
31 . . . Rod
311, 312 . . . End Portion of Rod
313 . . . Gap Between End Portion of Rod and Flange
32 . . . Projecting Member
33 . . . Stopper
34 . . . Elastic Member

1. An ion transport device, comprising:
a drift tube having a plurality of ring-shaped electrodes arranged in an axial direction;
a housing containing the drift tube;
a drift-tube support member configured to support the drift tube in relation to the housing;
a detector fixed to the drift tube and configured to detect ions; and
a vibration damper provided on the drift-tube support member and configured to absorb vibration which the drift-tube support member receives from the housing.

2. The ion transport device according to claim 1, further comprising:
a heater located on a lateral side of the drift tube within the housing and separately from the drift tube; and
a heater support member provided separately from the drift-tube support member and configured to support the heater in relation to the housing.

3. The ion transport device according to claim 1, wherein:
the drift tube includes ring-shaped electrodes and ring-shaped insulation members alternately stacked, and the device further comprises:
two flanges provided so as to clamp the drift tube from both ends;
a plurality of rods arranged on an outside of the drift tube so as to extend in the axial direction of the drift tube;
a plurality of insertion holes formed in one or both of the flanges and allowing each of the plurality of rods to be individually inserted into one of the insertion holes;
a stopper provided at an end portion of each of the rods on a side on which the rods are inserted into the insertion holes, the stopper having a larger diameter than the insertion holes; and
an elastic member located between the stopper and the flange in which the plurality of insertion holes are formed, the elastic member configured to urge the flange toward the drift tube.

4. The ion transport device according to claim 2, wherein:
the drift tube includes ring-shaped electrodes and ring-shaped insulation members alternately stacked, and the device further comprises:
two flanges provided so as to clamp the drift tube from both ends;
a plurality of rods arranged on an outside of the drift tube so as to extend in the axial direction of the drift tube;
a plurality of insertion holes formed in one or both of the flanges and allowing each of the plurality of rods to be individually inserted into one of the insertion holes;
a stopper provided at an end portion of each of the rods on a side on which the rods are inserted into the insertion holes, the stopper having a larger diameter than the insertion holes; and
an elastic member located between the stopper and the flange in which the plurality of insertion holes are formed, the elastic member configured to urge the flange toward the drift tube.

5. An ion transport device, comprising:
a drift tube having a plurality of ring-shaped electrodes arranged in an axial direction;
a housing containing the drift tube;
a drift-tube support member configured to support the drift tube in relation to the housing;
a detector fixed to the drift tube and configured to detect ions;
a heater located on a lateral side of the drift tube within the housing and separately from the drift tube; and
a heater support member provided separately from the drift-tube support member and configured to support the heater in relation to the housing.

6. An ion transport device, comprising:
a drift tube including ring-shaped electrodes and ring-shaped insulation members alternately stacked;
two flanges provided so as to clamp the drift tube from both ends;
a plurality of rods arranged on an outside of the drift tube so as to extend in an axial direction of the drift tube;
a plurality of insertion holes formed in one or both of the flanges and allowing each of the plurality of rods to be individually inserted into one of the insertion holes;
a stopper provided at an end portion of each of the rods on a side on which the rods are inserted into the insertion holes, the stopper having a larger diameter than the insertion holes; and
an elastic member located between the stopper and the flange in which the plurality of insertion holes are formed, the elastic member configured to urge the flange toward the drift tube.
